(19) United States
(12) Patent Application Publication
(10) Pub. No.: US 2025/0378206 A1
(43) Pub. Date: Dec. 11, 2025

(54) SECURITY PROTECTION METHOD FOR DRAWING FILE, APPARATUS, DEVICE, MEDIUM, AND PROGRAM PRODUCT

(71) Applicant: Beijing Volcano Engine Technology Co., Ltd., Beijing (CN)

(72) Inventors: Quan WANG, Beijing (CN); Xianglong MA, Beijing (CN); Huanxun CHEN, Beijing (CN); Chenhui CAI, Beijing (CN); Haoxiang CHENG, Beijing (CN)

(21) Appl. No.: 19/088,883

(22) Filed: Mar. 24, 2025

(30) Foreign Application Priority Data
Jun. 7, 2024 (CN) 202410741147.X

(51) Int. Cl. G06F 21/75; G06F 21/62

(52) U.S. Cl. CPC G06F 21/75; G06F 21/6209

(57) ABSTRACT

The present disclosure relates to the technical field of data security, and discloses a security protection method for a drawing file, an apparatus, a device, a medium, and a program product. The security protection method for a drawing file comprises: acquiring a first drawing file; acquiring a matching result of matching first feature information corresponding to the first drawing file with each second feature information in a target feature information set, where the first feature information is obtained by parsing the first drawing file to obtain description information of a target element in the first drawing file, and performing feature extraction on the obtained description information of the target element, and the target feature information set includes second feature information of at least one protected drawing file; and performing security protection management on the first drawing file based on the matching result.

### CROSS-REFERENCE TO RELATED APPLICATION(S)

This application claims priority to Chinese Application No. 202410741147.X filed Jun. 7, 2024, the disclosure of which is incorporated herein by reference in its entity.

### FIELD

The present disclosure relates to the technical field of data security, and in particular, to a security protection method for a drawing file, an apparatus, a device, a medium, and a program product.

### BACKGROUND

At present, in a private network/dedicated network of an enterprise or other organizations, security management software usually needs to be installed on terminal devices. Through the security management software, network access control, security detection, data leakage prevention protection, and the like can be performed on the terminal devices, and in particular, drawings in the terminal devices need to be protected against leakage.

### SUMMARY

In view of this, the present disclosure provides a security protection method for a drawing file, an apparatus a device, a medium, and a program product, to solve the problem of low security protection of the drawing file.

In a first aspect, the present disclosure provides a security protection method for a drawing file, comprising:
acquiring a first drawing file;
acquiring a matching result of matching first feature information corresponding to the first drawing file with each second feature information in a target feature information set, where the first feature information is obtained by parsing the first drawing file to obtain description information of a target element in the first drawing file, and performing feature extraction on the obtained description information of the target element, and the target feature information set includes second feature information of at least one protected drawing file; and
performing security protection management on the first drawing file based on the matching result.

In a second aspect, the present disclosure provides a security protection apparatus for a drawing file, comprising:
a first acquiring module, configured to acquire a first drawing file;
a second acquiring module, configured to acquire a matching result of matching first feature information corresponding to the first drawing file with each second feature information in a target feature information set, where the first feature information is obtained by parsing the first drawing file to obtain description information of a target element in the first drawing file, and performing feature extraction on the obtained description information of the target element, and the target feature information set includes second feature information of at least one protected drawing file; and
a management module, configured to perform security protection management on the first drawing file based on the matching result.

In a third aspect, the present disclosure provides a computer device, including a memory and a processor, where the memory and the processor are in communication with each other, the memory stores computer instructions, and the processor executes the computer instructions to perform the security protection method for a drawing file according to the first aspect or any one of the implementations thereof.

In a fourth aspect, the present disclosure provides a computer-readable storage medium, where the computer-readable storage medium stores computer instructions, and the computer instructions are used to enable a computer to perform the security protection method for a drawing file according to the first aspect or any one of the implementations thereof.

In a fifth aspect, the present disclosure provides a computer program product, including computer instructions, where the computer instructions are used to enable a computer to perform the security protection method for a drawing file according to the first aspect or any one of the implementations thereof.

According to the security protection method for a drawing file provided in this embodiment, security protection management is performed on the first drawing file based on a matching result of matching the first feature information corresponding to the first drawing file with each second feature information in the target feature information set. The first feature information is obtained by parsing the first drawing file to obtain the description information of the target element in the first drawing file and performing feature extraction on the description information. The target feature information set includes the second feature information of at least one protected drawing file. The description information of the target element can describe the target element from a semantic perspective, and the first feature information is obtained by performing feature extraction on this basis. That is, by incorporating a natural language idea into security protection of the drawing file, occurrence of false recognition or missing recognition can be effectively reduced, thereby improving the reliability and accuracy of the matching result and ensuring the security of the drawing.

### BRIEF DESCRIPTION OF THE DRAWINGS

In order to illustrate the technical solutions in the embodiments of the present disclosure more clearly, the following briefly introduces the drawings required for describing the embodiments or the prior art. Apparently, the drawings in the following description show some embodiments of the present disclosure, and for those of ordinary skill in the art, other drawings may also be obtained from these drawings without creative effort.

FIG. 1 is a schematic diagram of a network framework according to an embodiment of the present disclosure;

FIG. 2 is a schematic flowchart of a security protection method for a drawing file according to an embodiment of the present disclosure;

FIG. 3 is a schematic flowchart of another security protection method for a drawing file according to an embodiment of the present disclosure;

FIG. 4 is a schematic flowchart of another security protection method for a drawing file according to an embodiment of the present disclosure;

FIG. 5 is a structural block diagram of a security protection apparatus for a drawing file according to an embodiment of the present disclosure; and

FIG. 6 is a schematic diagram of a hardware structure of a computer device according to an embodiment of the present disclosure.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the protection scope of the present disclosure.

In the description of the embodiments of the present disclosure, the term “include/comprise” and similar terms should be understood as open inclusion, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below.

In this text, unless explicitly stated, performing a step “in response to A” does not mean that the step is performed immediately after “A”, but may include one or more intermediate steps.

It may be understood that data involved in the technical solution of the present disclosure (including but not limited to data itself, acquisition, use, storage or deletion of data) should comply with requirements of corresponding laws, regulations and relevant provisions.

It may be understood that before using the technical solution disclosed in the embodiments of the present disclosure, the type, use scope, use scene, etc. of the information involved in the present disclosure should be informed to the relevant user and the authorization of the relevant user should be obtained through an appropriate way according to the relevant laws and regulations, where the relevant user may include any type of right subject, such as an individual, an enterprise or a group.

For example, in response to receiving an active request from a user, prompt information is sent to the relevant user to explicitly prompt the relevant user that the operation requested to be performed will need to obtain and use the information of the relevant user, so that the relevant user can independently choose whether to provide information to software or hardware such as an electronic device, an application, a server or a storage medium that performs the operation of the technical solution of the present disclosure according to the prompt information.

As an optional but non-restrictive implementation, the way of sending the prompt information to the relevant user in response to receiving the active request from the relevant user may be, for example, a pop-up window, and the prompt information may be presented in the form of text in the pop-up window. In addition, the pop-up window may also carry a selection control for the user to select “agree” or “disagree” to provide information to the electronic device.

It may be understood that the above process of notifying and obtaining user authorization is only schematic, and does not constitute a limitation on the implementation of the present disclosure. Other methods that meet relevant laws and regulations may also be applied to the implementation of the present disclosure.

Office security usually involves security management of network, identity and terminal. By implementing private network networking, access control, management of terminals in the private network and information security protection, digital office can be made safer, more efficient and easier to use. The security management at the network layer can ensure the secure and efficient operation of private networks such as office networks, thereby ensuring the secure transmission and storage of service data. The security management at the identity layer can improve the efficiency and security of identity authentication for users to access private networks. The security management at the terminal layer can realize the unified management of terminal devices in the private network, data leakage prevention and terminal threat protection, thereby ensuring the security of enterprise data.

In practical applications, the security management of network, identity and terminal can realize the technical association in multiple technical branches such as networking strategy, network admission and control, remote access, unified terminal management, terminal detection and response, enterprise data leakage prevention and identity authentication management, thereby making digital office easier, more efficient and easier to implement.

In the related art, when there are many drawing files managed in an enterprise or other organizations, in order to ensure the access security of drawings, drawings are distinguished by means of drawing name identification, and then targeted access is performed. However, since the drawing name can be modified at will, and some drawings do not add the corresponding drawing name in the storage process, which will lead to the part of drawings cannot be effectively identified, thus affecting the access security of drawings.

Taking a circuit drawing as an example, production and manufacturing in the high-tech manufacturing industry depend on a circuit working principle provided by the circuit drawing. Therefore, in order to ensure the security of the drawing, a method capable of performing targeted security protection on a drawing file is urgently needed.

In view of this, an embodiment of the present disclosure provides a security protection method for a drawing file. After acquiring a first drawing file, security protection management is performed on the first drawing file based on a matching result of matching first feature information corresponding to the first drawing file with each second feature information in a target feature information set, which can effectively reduce occurrence of false recognition or missing recognition, thereby improving the reliability and accuracy of the matching result. The first feature information is obtained by parsing the first drawing file to obtain description information of a target element in the first drawing file, and performing feature extraction on the obtained description information of the target element. The target feature information set includes second feature information of at least one protected drawing file.

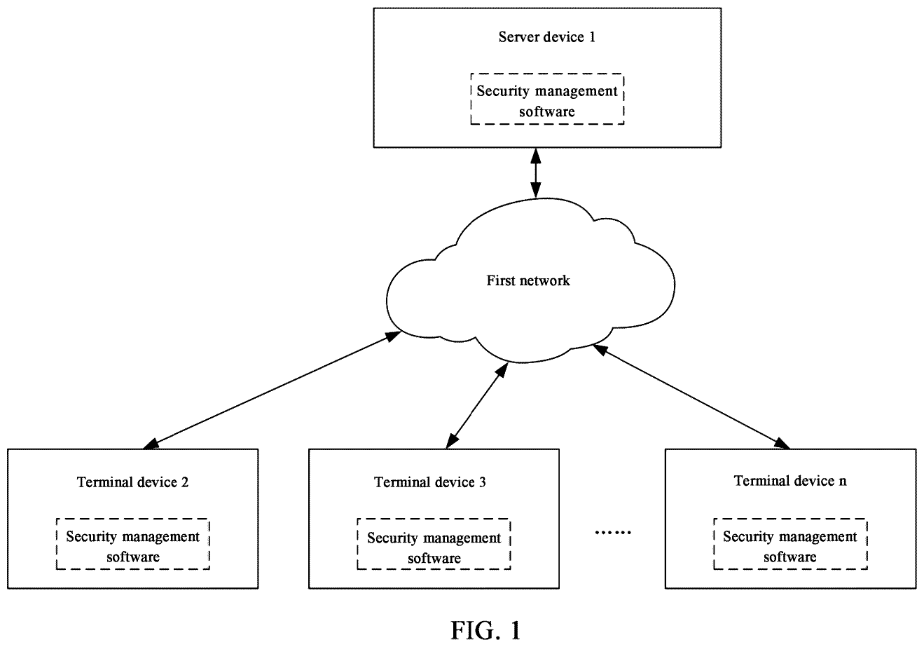

As an optional application scenario of the security protection method for a drawing file provided in the embodiment of the present disclosure, as shown in FIG. 1, a server of security management software is installed on a server device 1, clients of the security management software are installed on terminal devices 2 to n, and the server and the clients are in communication connection through a first network, so as to perform security protection on drawing files in the terminal devices 2 to n.

According to the embodiment of the present disclosure, an embodiment of a security protection method for a drawing file is provided. It should be noted that the steps shown in the flowchart may be performed in a computer system such as a set of computer-executable instructions, and although a logical order is shown in the flowchart, in some cases, the steps shown or described may be performed in an order different from that here.

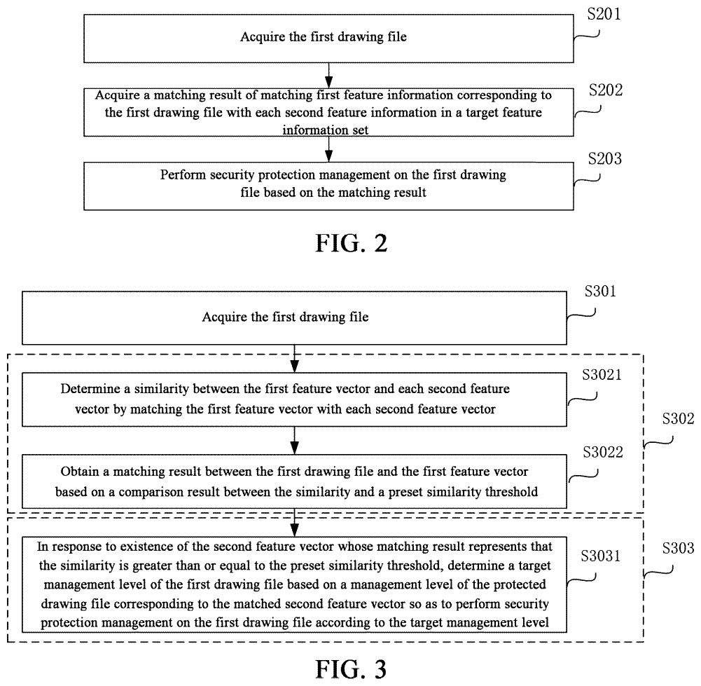

In this embodiment, a security protection method for a drawing file is provided, which may be used for the client of the security management software in the above terminal device. FIG. 2 is a flowchart of a security protection method for a drawing file according to an embodiment of the present disclosure. As shown in FIG. 2, the flow comprises the following steps.

In S201, a first drawing file is acquired.

The first drawing file may be an offline drawing stored locally or an online drawing. The type of the first drawing file may be a circuit drawing, an architectural drawing, an interior design drawing, or the like, which may be determined according to an actual service.

The acquisition source of the first drawing file may be obtained locally or from a cloud server, or may be acquired by means of downloading, editing or creating. The format of the drawing file may include, but is not limited to, any of the following: .schdoc (a circuit diagram file format of a software), .kicad_sch (a circuit diagram file format of a software), .edf (a native drawing file format of a software), and the like. Which format of the drawing file is specifically used depends on actual design requirements, software compatibility and data exchange requirements, which are not limited here.

In S202, a matching result of matching first feature information corresponding to the first drawing file with each second feature information in a target feature information set is acquired.

The first feature information is obtained by parsing the first drawing file to obtain description information of a target element in the first drawing file, and performing feature extraction on the obtained description information of the target element. It should be noted that the first drawing file may be parsed at a client of the security management software, or may be parsed at a server of the security management software, which is not limited here. Taking the server of the security management software as an example, the client sends the first drawing file to the server, and the server parses the first drawing file and performs other processing to obtain the first feature information, and matches the first feature information with each second feature information in the target feature information set to obtain the matching result, and sends the matching result to the client. Correspondingly, the client can obtain the matching result.

Since the first drawing file is an unknown drawing file, in order to know the drawing content in the first drawing file, the first drawing file is parsed to concretize the drawing content in the first drawing file, thereby obtaining the description information of the target element in the first drawing file. For example, taking the first drawing file as a circuit drawing as an example, the description information may include a connection relationship between pins corresponding to target electronic components in the circuit drawing and annotation information. The annotation information includes, but is not limited to, information such as a name, a model, a value, power, and working conditions of the component. For another example, taking the first drawing file as a mechanical drawing as an example, the description information may include information such as a size, a shape, and an installation manner corresponding to each target part in the circuit drawing. In the parsing process, parsing may be performed by means of semantic recognition, text matching, or using a specified code parsing tool. For example, if semantic recognition is used for parsing, a first drawing file may be converted into an abstract syntax tree (Abstract Syntax Tree, AST) by a pre-set lexical analyzer (lexer) and a parser, and then description information of the target electronic component is extracted from the AST. If text matching is used for parsing, information extraction may be performed by means of identifying a keyword, a variable name, a function name, etc. of the target element, thereby obtaining the description information of the target element. A specific parsing process may be determined according to an actual parsing manner, which is not limited here.

Feature extraction is performed on the description information to reduce interference of redundant data, thereby obtaining first feature information capable of expressing key content of the first drawing file. For example, feature extraction may be performed by means of performing hash processing or one-hot encoding on the description information, and a specific feature extraction process may be determined according to actual requirements.

The target feature information set includes second feature information of at least one protected drawing file. The protected drawing file may be understood as a drawing file whose drawing content is previously specified to need protection. In order to determine the matching between the first drawing file and each protected drawing file, the first feature information corresponding to the first drawing file is matched with each second feature information in the target feature information set, so as to clarify the difference between the first feature information and each second feature information through the obtained matching result, thereby facilitating subsequent quick identification of whether the first drawing file needs targeted security protection, thereby effectively reducing occurrence of false recognition or missing recognition, and improving the reliability and accuracy of the matching result.

In S203, security protection management is performed on the first drawing file based on the matching result.

Through the matching result, the matching between the first drawing file and each protected drawing file can be determined, and then targeted security protection management may be performed on the first drawing file based on the matching. The security protection management includes, but is not limited to, means for protecting the first drawing file such as blocking, releasing, or adding a protection identification.

For example, if the matching result represents that the first drawing file is a protected drawing file, a preset operation on the first drawing file is blocked. If the matching result represents that the first drawing file is not a protected drawing file, the preset operation on the first drawing file is released. Alternatively, if the matching result represents that the first drawing file is not a protected drawing file, the preset operation on the first drawing file is released, but a protection identification is added to the first drawing file to improve the transmission security of the first drawing file.

According to the security protection method for a drawing file provided in this embodiment, security protection management is performed on the first drawing file based on a matching result of matching the first feature information corresponding to the first drawing file with each second feature information in the target feature information set. The first feature information is obtained by parsing the first drawing file to obtain the description information of the target element in the first drawing file and performing feature extraction on the description information. The target feature information set includes the second feature information of at least one protected drawing file. The description information of the target element can describe the target element from a semantic perspective, and the first feature information is obtained by performing feature extraction on this basis. That is, by incorporating a natural language idea into security protection of the drawing file, occurrence of false recognition or missing recognition can be effectively reduced, thereby improving the reliability and accuracy of the matching result and ensuring the security of the drawing.

In some optional implementations, S201 comprises the following step.

In step al, the first drawing file is acquired in response to a preset operation on the first drawing file.

The preset operation includes at least one of: sending the first drawing file to an outside of the first network, downloading the first drawing file, creating the first drawing file, or editing the first drawing file. That is, after the preset operation on the first drawing file is detected, in order to ensure the security of the first drawing file, the first drawing file is acquired, so that subsequent targeted security protection management can be performed on the first drawing file to improve the access security of the first drawing file. The first network may be understood as an intranet used by an enterprise or other organizations.

In some other optional implementations, when performing security protection management on the first drawing file based on the matching result, a preset operation on the first drawing file may be blocked in response to the matching result representing that the first drawing file is a protected drawing file, or the preset operation on the first drawing file may be released in response to the matching result representing that the first drawing file is not a protected drawing file, so as to improve the flexibility of security access management on the first drawing file.

In some optional implementation scenarios, if the first drawing file is a circuit drawing, the target element in the first drawing file is the target electronic component. The circuit drawing is a drawing used to describe circuit connection and component configuration. The function, structure and working principle of the circuit can be clearly displayed through the circuit drawing, which is one of the basic tools for electronic engineers to perform circuit design and troubleshooting. For example, the target electronic component may be a capacitor, a resistor, an inductor, a potentiometer, a tube, a connector, a sensor, or the like. The file format of the circuit drawing may include, but is not limited to, .schdoc (a format used to describe a circuit diagram), .kicad_sch (a format used to describe a circuit diagram), .brd (a layout file format), and the like.

If the first drawing file is an engineering drawing, the target element in the first drawing file is an architectural structure, a mechanical part, a pipeline layout, or the like. The engineering drawing refers to a drawing used for engineering design and construction, and is one of the important documents in the engineering project. The engineering drawing usually includes various types such as an architectural drawing, a structural drawing, an electrical drawing, and a pipeline drawing, and a specific target element is determined according to the content of the engineering drawing. For example, if the type of the engineering drawing is an architectural drawing, the corresponding target element is the target building component. For example, the target building component may be a plate, a beam, a column, a wall, or the like.

If the type of the engineering drawing is a mechanical drawing, the corresponding target element is the target part. For example, the target part may be a shaft, a gear, a coupling, a valve, or the like. Different types of engineering drawings correspond to different target elements.

The process of parsing the first drawing file is specifically described below by taking the first drawing file as a circuit drawing as an example.

In step bl, source code of the circuit drawing is parsed to obtain description information of a target electronic component in the circuit drawing.

The source code is a text file generated when a circuit schematic diagram is created through a specified application. The file format of the source code depends on the file format supported by the corresponding application, and different applications may support different file formats, for example, the file format may be .sch or .brd, etc.

If the circuit drawing is not changed, the source code usually will not change. Therefore, in order to fully understand the layout principle and execution logic of the circuit to be detected in the circuit drawing, the source code of the circuit drawing is acquired to obtain the specific description information of the circuit to be detected through the source code.

In order to clarify the circuit structure and layout characteristics of the circuit to be detected, the source code is parsed to obtain description information capable of specifically describing the principle of the circuit to be detected. The description information includes, but is not limited to, the following content: target electronic components, pin connection conditions of the target electronic components, annotation information, and the like. The annotation information includes, but is not limited to, information such as a name of the target electronic component, a pin function, and a circuit design description.

In some optional implementations, step b1 comprises the following step.

In step b11, field parsing is performed on source code of the circuit drawing to determine a target electronic component in the circuit drawing.

In order to determine the target electronic component involved in the circuit to be detected in the circuit drawing, field parsing is performed on the source code to identify a field or position where the description information of the target electronic component is located. For example, a specific field or mark where the target electronic component is located may be determined according to the syntax and structure of the source code, and then targeted parsing is performed to determine the target electronic component in the circuit drawing from it, which contributes to ensuring the determination reliability of the target electronic component.

Specifically, step b11 comprises the following steps.

In step b111, field parsing is performed on the source code to determine a field in the circuit drawing.

In step b112, the field is filtered to determine a target field, and an electronic component corresponding to the target field is used as the target electronic component.

Specifically, the source code may include information that is not related to the circuit structure of the circuit to be detected, such as definitions of various variables and functions, code control structure, code comments, and syntax and rules specific to a programming language. Therefore, in order to reduce interference of invalid information, field parsing is performed on the source code to determine a field related to the electronic component from it. For example, the field related to the electronic component may include information such as a name, a model, a parameter, and a connection manner of the electronic component.

In order to determine the target electronic component, the field obtained through parsing is further filtered to determine a field directly related to the electronic component from it, thereby obtaining the target field, and the electronic component corresponding to the target field is used as the target electronic component. For example, a field library corresponding to the electronic component is preset. The field library includes fields of multiple candidate electronic components. The parsed field is matched with the fields of the multiple candidate electronic components, and the matched field is used as the target field.

The target field is determined through field parsing and filtering, so that information related to the circuit structure can be quickly located in the source code, and then when feature extraction is performed subsequently, it is possible to focus on information related to the circuit to be detected, thereby contributing to improving the determination efficiency of the target electronic component.

In step b12, description information of the target electronic component is extracted from the source code.

In order to determine the layout of the target electronic component in the circuit to be detected, the description information of the target electronic component is extracted from the source code, so that the layout setting and layout planning between the target electronic components can be determined according to the description information, thereby improving the reliability of the first feature information when feature extraction is performed subsequently.

Specifically, step b12 comprises the following step.

In step b121, a connection relationship between the target electronic components and model information of the target electronic component are extracted to obtain the description information.

In order to determine the signal flow path between the target electronic components and the interaction relationship between the target electronic components in the circuit to be detected, the connection relationship between the target electronic components is extracted from the source code. The connection relationship may be determined according to pin information of the target electronic component.

Further, since electronic components of different models perform different functions, in order to better locate the function of the target electronic component in the circuit to be detected, the model information of the target electronic component is extracted from the source code, and then in combination with the connection relationship between the corresponding target electronic component and other target electronic components, the description information of the target electronic component is obtained, thereby contributing to better understanding and analyzing the role of the target electronic component in the circuit to be detected.

The description information of the target electronic component is determined by means of parsing the source code of the first drawing file, so that the layout position of the target electronic component in the circuit to be detected and the function performed by the target electronic component can be quickly located, and then when feature extraction is performed, interference of invalid information can be effectively avoided, and the reliability and accuracy of the first feature information can be improved. Therefore, when security access management is performed on the first drawing file based on the matching result of matching the first feature information with each second feature information in the target feature information set, the pertinence and accuracy of security protection can be effectively improved.

In some optional implementations, in order to make the first feature information more reliable and fully express the layout position of each target electronic component in the circuit to be detected and the corresponding function performed, feature processing is performed on the description information of each target electronic component, and then the electronic component features of multiple target electronic components are integrated to obtain a first feature vector corresponding to the first feature information. That is, feature extraction processing is performed on the description information of the current target electronic component to obtain the electronic component feature of the current target electronic component in the circuit to be detected. After the feature processing is performed on the description information of all the target electronic components, all the obtained electronic component features are integrated to obtain the first feature vector capable of representing a specific circuit principle of the circuit to be detected.

In this embodiment, a security protection method for a drawing file is provided, which may be used for the client of the security management software in the terminal device. FIG. 3 is a flowchart of a security protection method for a drawing file according to an embodiment of the present disclosure. As shown in FIG. 3, the flow comprises the following steps.

In S301, a first drawing file is acquired.

In S302, a matching result of matching first feature information corresponding to the first drawing file with each second feature information in a target feature information set is acquired.

Specifically, S302 comprises the following steps.

In S3021, a first feature vector is matched with each second feature vector to determine a similarity between the first feature vector and each second feature vector.

The first feature vector corresponds to the first feature information, and the second feature vector corresponds to the second feature information.

The first feature information and the second feature information are expressed in the form of feature vectors respectively, so that the difficulty of feature matching can be reduced when feature matching is performed subsequently. The dimension of the feature vector corresponds to the number of features. In some examples, the vector dimension of the first feature vector is the same as the vector dimension of the second feature vector.

In order to determine the matching between the first feature vector and the second feature vector, a cosine value between the first feature vector and the second feature vector is determined, and then according to the size of the cosine value, the similarity between the first feature vector and the second feature vector can be determined, thereby contributing to improving the accuracy of determining the similarity. The cosine value between the first feature vector and the second feature vector may be determined by the following formula:

$$S ( A , B ) = \frac{A \cdot B}{‖ A ‖ \times ‖ B ‖} = \frac{{\sum }_{i = 1}^{n} ( {A}_{i} \times {B}_{i} )}{\sqrt{{\sum }_{i = 1}^{n} {A}_{i}^{2}} \times \sqrt{{\sum }_{i = 1}^{n} {B}_{i}^{2}}} ,$$

where S(A, B) represents the cosine value between the first feature vector and the second feature vector, A represents the first feature vector, B represents the second feature vector, i represents the feature of the current dimension, and n represents the total number of dimensions of the feature vector. The value range of S(A, B) is [−1, 1]. If the value of S(A, B) is −1, it represents that the first feature vector and the second feature vector are completely dissimilar. If the value of S(A, B) is 1, it represents that the first feature vector and the second feature vector are completely similar.

In S3022, a matching result between the first drawing file and the second feature vector is obtained based on a comparison result between the similarity and a preset similarity threshold.

In order to identify whether the first drawing file is the same as the protected circuit drawing, the obtained similarity is compared with the preset similarity threshold to determine the comparison result between the two, and then the matching result is determined according to the comparison result, which can effectively improve the efficiency of security protection management on the first drawing file. The preset similarity threshold may be understood as the minimum similarity for the first feature vector to match with the second feature vector. For example, if the comparison result represents that the similarity is greater than or equal to the preset similarity threshold, it represents that the first drawing file matches with the protected circuit drawing, and then it may be determined that the first drawing file is a protected drawing file. If the comparison result represents that the similarity is less than the preset similarity threshold, it represents that the first drawing file does not match with the protected circuit drawing, and then it may be determined that the first drawing file is not a protected drawing file.

In S303, security protection management is performed on the first drawing file based on the matching result.

Specifically, S303 comprises the following step.

In S3031, in response to existence of the second feature vector whose matching result represents that the similarity is greater than or equal to the preset similarity threshold, a target management level of the first drawing file is determined according to a management level of the protected drawing file corresponding to the matched second feature vector, so as to perform security protection management on the first drawing file according to the target management level.

Specifically, if the matching result represents that the similarity is greater than or equal to the preset similarity threshold, it represents that the first drawing file matches with the protected circuit drawing. Therefore, in order to improve the management efficiency of the first drawing file, the target management level of the first drawing file may be determined according to the management level of the protected drawing file corresponding to the matched second feature vector, so that the first drawing file may be managed according to the target management level subsequently, thereby ensuring timeliness of management on the first drawing file and contributing to reducing the cost of supervision on the circuit drawing.

According to the security protection method for a drawing file provided in this embodiment, the target electronic component in the circuit drawing can be automatically detected and identified, and the working efficiency and accuracy are improved. At the same time, whether the first drawing file is a protected drawing file is judged by means of feature vector matching, which can effectively avoid occurrence of missing recognition or false recognition, thereby effectively improving the accuracy and reliability of security protection management of the drawing file.

In some optional implementations, the number of pieces of the second feature information in the target feature information set may be plural, and corresponding services or products may be not completely the same. In order to avoid occurrence of missing recognition, in the process of performing security protection on the first drawing file, the first feature vector of the first drawing file may be matched with each second feature vector, and then according to the matching result between the first feature vector and each second feature vector, whether there is a second feature vector whose similarity with the first feature vector is greater than or equal to the preset similarity threshold among the plurality of second feature vectors is determined, thereby contributing to improving the accuracy of the matching result.

In some optional implementations, the method is applied to a client of security management software. Based on this, the method further comprises: receiving the target feature information set delivered by a server of the security management software. In the production and manufacturing process of an enterprise or other organizations, when many links are involved, the security protection accuracy of the drawing file may be affected due to reasons such as service isolation. Therefore, in order to ensure the protection security of the drawing file, the target feature information set may be delivered by the server of the security management software to the client of the security management software, so that when detecting the prediction operation on the first drawing file, the client of the security management software may perform targeted security protection management on the first drawing file based on the obtained target feature information set, thereby improving the efficiency of security protection management on the first drawing file and ensuring timeliness of security protection on the first drawing file.

As a specific application embodiment of the embodiment of the present disclosure, the server of the security management software A is installed in the server device 1, and the clients of the security management software A are installed in the terminal devices 2 to n, respectively. Through interaction with the server of the security management software A, a plurality of drawing files that need to be protected are determined. Based on source code of each drawing file that needs to be protected, the second feature information of each drawing file that needs to be protected is determined, thereby obtaining the target feature information set. The server of the security management software A delivers the target feature information set to the corresponding client of the security management software A, for example, the terminal devices 2 to n. On this basis, the terminal devices 2 to n can use the target feature information set to identify the currently acquired first drawing file, and then perform targeted security protection management on the first drawing file.

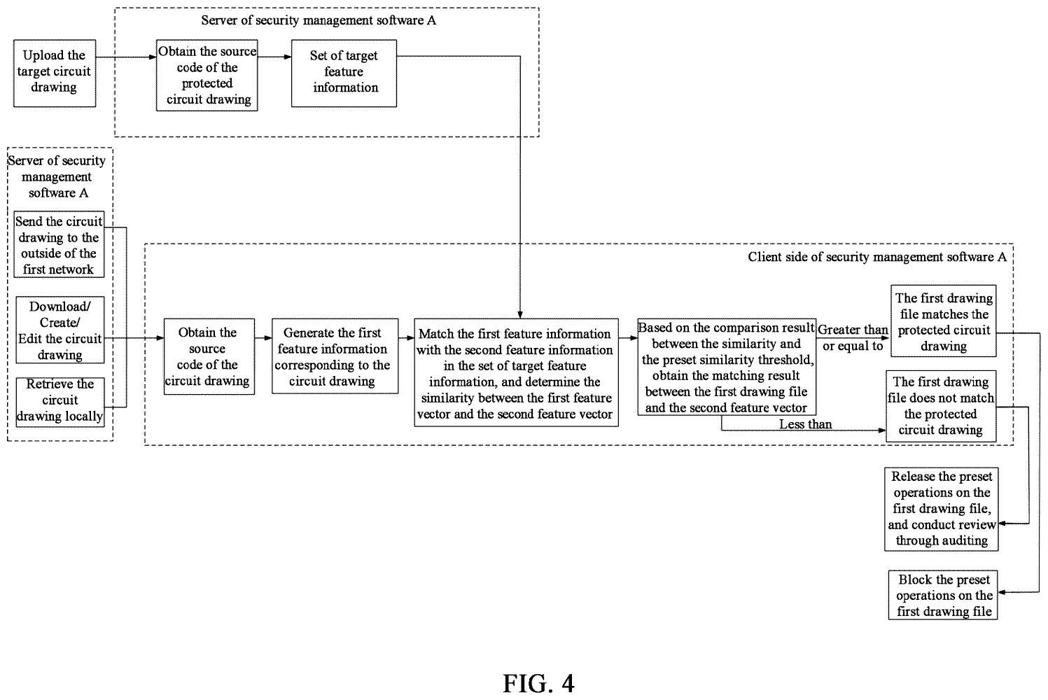

Specifically, taking the first drawing file as a circuit drawing as an example, the process of performing security protection on the drawing file for the circuit drawing in the device where the client of the security management software A is located is as shown in FIG. 4, and comprises the following steps.

Source code of the circuit drawing is acquired, where the circuit drawing may be acquired by the client of the security management software A in response to a preset operation on the circuit drawing. The preset operation includes at least one of: sending the circuit drawing to an outside of the first network, downloading the circuit drawing, creating the circuit drawing, editing the circuit drawing, or retrieving the circuit drawing locally.

The source code is parsed to obtain description information of a target electronic component in the circuit drawing, and then feature extraction is performed on the description information to obtain first feature information corresponding to the circuit drawing.

The first feature information is matched with second feature information in a target feature information set to determine a similarity between a first feature vector and a second feature vector. A matching result between the first drawing file and the second feature vector is obtained based on a comparison result between the similarity and a preset similarity threshold. If the comparison result represents that the similarity is greater than or equal to the preset similarity threshold, it represents that the first drawing file matches with the protected circuit drawing, and it is determined that the first drawing file is a protected drawing file. If the comparison result represents that the similarity is less than the preset similarity threshold, it represents that the first drawing file does not match with the protected circuit drawing, and it is determined that the first drawing file is not a protected drawing file. The target feature information set is delivered by the server of the security management software A. The second feature information is feature information of the protected drawing file. The second feature information is obtained by parsing the source code of the protected circuit drawing, and then performing feature extraction on the obtained description information of the target electronic component in the protected circuit drawing.

If the matching result represents that the first drawing file is a protected drawing file, the preset operation on the first drawing file is blocked. If the matching result represents that the first drawing file is not a protected drawing file, the preset operation on the first drawing file is released, and then the circuit drawing may be sent to an audit for review subsequently.

Through the above security protection method for a drawing file, it can be ensured that the extraction process of the first feature information is not affected by modification of a drawing suffix or a name, thereby improving the reliability of the first feature information. Therefore, when security protection is performed on the drawing file subsequently, occurrence of missing recognition or false recognition can be effectively reduced, thereby effectively improving the accuracy and reliability of security protection on the drawing file.

In this embodiment, a security protection apparatus for a drawing file is further provided. The apparatus is used to implement the above embodiments and preferred implementations, which will not be repeated here. As used below, the term “module” may implement a combination of software and/or hardware for a predetermined function. Although the apparatus described in the following embodiments is preferably implemented in software, the implementation in hardware, or a combination of software and hardware is also possible and contemplated.

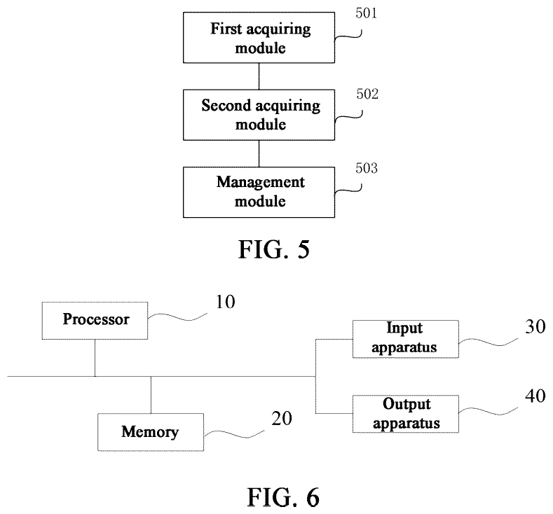

In this embodiment, a security protection apparatus for a drawing file is provided. As shown in FIG. 5, the apparatus includes a first acquiring module 501, a second acquiring module 502, and a management module 503.

The first acquiring module 501 is configured to acquire a first drawing file.

The second acquiring module 502 is configured to acquire a matching result of matching first feature information corresponding to the first drawing file with each second feature information in a target feature information set, where the first feature information is obtained by parsing the first drawing file to obtain description information of a target element in the first drawing file, and performing feature extraction on the obtained description information of the target element, and the target feature information set includes second feature information of at least one protected drawing file.

The management module 503 is configured to perform security protection management on the first drawing file based on the matching result.

In some optional implementations, the first acquiring module 501 comprises:
a file acquiring unit, configured to acquire the first drawing file in response to a preset operation on the first drawing file,
where the preset operation includes at least one of: sending the first drawing file to an outside of the first network, downloading the first drawing file, creating the first drawing file, or editing the first drawing file.

In some optional implementations, the management module 503 comprises:
a first management unit, configured to block a preset operation on the first drawing file in response to the matching result representing that the first drawing file is a protected drawing file; or
a second management unit, configured to release a preset operation on the first drawing file in response to the matching result representing that the first drawing file is not a protected drawing file.

In some optional implementations, the first drawing file is a circuit drawing, and the target element in the first drawing file is a target electronic component; and
the module configured to parse the first drawing file to obtain the description information of the target element in the first drawing file comprises:
a parsing unit, configured to parse source code of the circuit drawing to obtain the description information of the target electronic component in the circuit drawing.

In some optional implementations, the parsing unit comprises:
a first processing unit, configured to perform field parsing on the source code of the circuit drawing to determine the target electronic component in the circuit drawing; and
a second processing unit, configured to extract the description information of the target electronic component from the source code.

In some optional implementations, the first processing unit comprises:
a first executing unit, configured to perform field parsing on the source code to determine a field in the circuit drawing; and
a filtering unit, configured to filter the field to determine a target field, and use an electronic component corresponding to the target field as the target electronic component.

In some optional implementations, the second processing unit comprises:
an extracting unit, configured to extract a connection relationship between the target electronic components and model information of the target electronic component to obtain the description information.

In some optional implementations, the second acquiring module 502 comprises:
a matching unit, configured to match the first feature vector with the second feature vector to determine the similarity between the first feature vector and each second feature vector, where the first feature vector corresponds to the first feature information, and the second feature vector corresponds to the second feature information; and
a third processing unit, configured to obtain the matching result between the first feature information and each second feature information based on the comparison result between the similarity and the preset similarity threshold.

In some optional implementations, the management module 503 comprises:
a fourth processing unit, configured to determine the target management level of the first drawing file according to the management level of the protected drawing file corresponding to the matched second feature vector in response to existence of the second feature vector whose matching result represents that the similarity is greater than or equal to the preset similarity threshold, so as to perform security protection management on the first drawing file according to the target management level.

In some optional implementations, the security protection apparatus for a drawing file is applied to a client of security management software, and the security protection apparatus further comprises:
a receiving unit, configured to receive the target feature information set delivered by a server of the security management software.

For further functional descriptions of the above modules and units, reference may be made to the above corresponding embodiments, which will not be repeated here.

In this embodiment, the security protection apparatus for a drawing file is presented in the form of functional units. The unit here refers to an ASIC (Application Specific Integrated Circuit) circuit, a processor and a memory that execute one or more software or fixed programs, and/or other devices that can provide the above functions.

The embodiment of the present disclosure further provides a computer device, which has the security protection apparatus for a drawing file shown in FIG. 5.

Referring to FIG. 6, FIG. 6 is a schematic diagram of a structure of a computer device according to an optional embodiment of the present disclosure. As shown in FIG. 6, the computer device includes: one or more processors 10, a memory 20, and interfaces for connecting various components, including a high-speed interface and a low-speed interface. The various components are in communication with each other by using different buses, and may be installed on a public mainboard or installed in other manners as required. The processor may process instructions executed in the computer device, including instructions stored in the memory or on the memory to display graphic information of a GUI on an external input/output apparatus (such as a display device coupled to the interface). In some optional implementations, if necessary, multiple processors and/or multiple buses may be used together with multiple memories. Similarly, multiple computer devices may be connected, and each device provides part of necessary operations (for example, as a server array, a group of blade servers, or a multi-processor system). FIG. 6 takes one processor 10 as an example.

The processor 10 may be a central processor, a network processor, or a combination thereof. The processor 10 may further include a hardware chip. The hardware chip may be an application-specific integrated circuit, a programmable logic device, or a combination thereof. The programmable logic device may be a complex programmable logic device, a field programmable gate array, a general-purpose array logic, or any combination thereof.

The memory 20 stores instructions executable by at least one processor 10, to cause the at least one processor 10 to perform the method shown in the above embodiments.

The memory 20 may include a program storage area and a data storage area, where the program storage area may store an operating system and applications required for at least one function; and the data storage area may store data created according to the use of the computer device, and the like. In addition, the memory 20 may include a high-speed random-access memory, and may also include a non-transitory memory, such as at least one magnetic disk storage device, a flash memory device, or other non-transitory solid-state storage devices. In some optional implementations, the memory 20 may optionally include a memory remotely provided relative to the processor 10, and these remote memories may be connected to the computer device through a network. Examples of the network include, but are not limited to, the Internet, an intranet, a local area network, a mobile communication network, and a combination thereof.

The memory 20 may include a volatile memory, such as a random-access memory; the memory may also include a non-volatile memory, such as a flash memory, a hard disk, or a solid-state drive; the memory 20 may further include a combination of the above-mentioned types of memories.

The computer device further includes an input apparatus 30 and an output apparatus 40. The processor 10, the memory 20, the input apparatus 30, and the output apparatus 40 may be connected by means of a bus or in other manners, and FIG. 6 takes connection by means of a bus as an example.

The input apparatus 30 may receive input digital or character information, and generate key signal input related to user settings and function control of the computer device, such as a touchscreen, a keypad, a mouse, a trackpad, a touchpad, a pointing stick, one or more mouse buttons, a trackball, a joystick, and the like. The output apparatus 40 may include a display device, an auxiliary lighting apparatus (for example, an LED), a tactile feedback apparatus (for example, a vibration motor), and the like. The above display device includes, but is not limited to, a liquid crystal display, a light emitting diode, a display, and a plasma display. In some optional implementations, the display device may be a touchscreen.

The embodiment of the present disclosure further provides a computer-readable storage medium. The method according to the embodiment of the present disclosure may be implemented in hardware and firmware, or may be implemented as computer codes that may be recorded in a storage medium or downloaded through a network and are originally stored in a remote storage medium or a non-transitory machine-readable storage medium and are to be stored in a local storage medium, so that the method described herein may be stored in such software processing on a storage medium using a general-purpose computer, a dedicated processor, or programmable or dedicated hardware. The storage medium may be a magnetic disk, an optical disk, a read-only memory, a random-access memory, a flash memory, a hard disk, a solid-state drive, or the like; further, the storage medium may further include a combination of the above-mentioned types of memories. It may be understood that a computer, a processor, a microprocessor controller, or programmable hardware includes a storage component that may store or receive software or computer codes, and when the software or computer codes are accessed and executed by the computer, the processor, or the hardware, the method shown in the above embodiments is implemented.

A part of the present disclosure may be applied as a computer program product, such as computer program instructions, which when executed by a computer, may invoke or provide the method and/or technical solution according to the present disclosure through the operation of the computer. Those skilled in the art should understand that the existence form of computer program instructions in a computer-readable medium includes but is not limited to a source file, an executable file, an installation package file, and the like; accordingly, the manner in which the computer program instructions are executed by a computer includes but is not limited to: the computer directly executes the instructions, or the computer compiles the instructions and then executes a corresponding post-compilation program, or the computer reads and executes the instructions, or the computer reads and installs the instructions and then executes a corresponding post-installation program. Here, the computer-readable medium may be any available computer-readable storage medium or communication medium accessible by a computer.

Although the embodiments of the present disclosure are described with reference to the drawings, those skilled in the art may make various modifications and variations without departing from the spirit and scope of the present disclosure, and such modifications and variations fall within the scope defined by the appended claims.

I/We claim:

1. A security protection method for a drawing file, comprising:
acquiring a first drawing file;
acquiring a matching result of matching first feature information corresponding to the first drawing file with each second feature information in a target feature information set, wherein the first feature information is obtained by parsing the first drawing file to obtain description information of a target element in the first drawing file, and performing feature extraction on the obtained description information of the target element, and the target feature information set comprising second feature information of at least one protected drawing file; and
performing security protection management on the first drawing file based on the matching result.

2. The method according to claim 1, wherein acquiring the first drawing file comprises:
in response to a preset operation on the first drawing file, acquiring the first drawing file,
wherein the preset operation comprises at least one of: sending the first drawing file to an outside of the first network, downloading the first drawing file, creating the first drawing file, or editing the first drawing file.

3. The method according to claim 1, wherein performing security protection management on the first drawing file based on the matching result comprises:
in response to the matching result representing that the first drawing file is a protected drawing file, blocking a preset operation on the first drawing file; or
in response to the matching result representing that the first drawing file is not a protected drawing file, releasing a preset operation on the first drawing file.

4. The method according to claim 1, wherein the first drawing file is a circuit drawing, and the target element in the first drawing file comprises a target electronic component; and parsing the first drawing file to obtain the description information of the target element in the first drawing file comprises:
obtaining the description information of the target electronic component in the circuit drawing by parsing source code of the circuit drawing.

5. The method according to claim 4, wherein obtaining the description information of the target electronic component in the circuit drawing by parsing the source code of the circuit drawing comprises:
determining the target electronic component in the circuit drawing by performing field parsing on source code of the circuit drawing; and
extracting the description information of the target electronic component from the source code.

6. The method according to claim 5, wherein determining the target electronic component in the circuit drawing by performing field parsing on the source code of the circuit drawing comprises:
determining a field in the circuit drawing by performing the field parsing on the source code; and
determining a target field by filtering the field, and taking an electronic component corresponding to the target field as the target electronic component.

7. The method according to claim 5, wherein extracting the description information of the target electronic component from the source code comprises:
extracting a connection relationship between the target electronic component and model information of the target electronic component to obtain the description information.

8. The method according to claim 1, wherein acquiring the matching result of matching the first feature information corresponding to the first drawing file with each second feature information in the target feature information set comprises:
determining a similarity between a first feature vector and each second feature vector by matching the first feature vector with each of the second feature vector, the first feature vector corresponding to the first feature information, and the second feature vector corresponding to the second feature information; and
obtaining the matching result between the first feature information and each of the second feature information based on a comparison result between the similarity and a preset similarity threshold.

9. The method according to claim 8, wherein performing security protection management on the first drawing file based on the matching result comprises:
in response to existence of the second feature vector whose matching result represents that the similarity is greater than or equal to the preset similarity threshold, determining a target management level of the first drawing file based on a management level of the protected drawing file corresponding to the matched second feature vector, so as to perform the security protection management on the first drawing file according to the target management level.

10. The method according to claim 1, wherein the method is applied to a client of a security management software, and the method further comprises:
receiving the target feature information set delivered by a server of the security management software.

11. A computer device, comprising:
a memory and a processor, in communication with each other, wherein the memory stores computer instructions therein, and the processor executes the computer instructions to:
acquire a first drawing file;
acquire a matching result of matching first feature information corresponding to the first drawing file with each second feature information in a target feature information set, wherein the first feature information is obtained by parsing the first drawing file to obtain description information of a target element in the first drawing file, and performing feature extraction on the obtained description information of the target element, and the target feature information set comprising second feature information of at least one protected drawing file; and
perform security protection management on the first drawing file based on the matching result.

12. The computer device according to claim 11, wherein the computer instructions to acquire the first drawing file comprise instructions to:
in response to a preset operation on the first drawing file, acquire the first drawing file,
wherein the preset operation comprises at least one of: sending the first drawing file to an outside of the first network, downloading the first drawing file, creating the first drawing file, or editing the first drawing file.

13. The computer device according to claim 11, wherein the computer instructions to perform security protection management on the first drawing file based on the matching result comprise instructions to:
in response to the matching result representing that the first drawing file is a protected drawing file, block a preset operation on the first drawing file; or
in response to the matching result representing that the first drawing file is not a protected drawing file, release a preset operation on the first drawing file.

14. The computer device according to claim 11, wherein the first drawing file is a circuit drawing, and the target element in the first drawing file comprises a target electronic component; and the computer instructions to parse the first drawing file to obtain the description information of the target element in the first drawing file comprise instructions to:
obtain the description information of the target electronic component in the circuit drawing by parsing source code of the circuit drawing.

15. The computer device according to claim 14, wherein the computer instructions to obtain the description information of the target electronic component in the circuit drawing by parsing the source code of the circuit drawing comprise instructions to:
determine the target electronic component in the circuit drawing by performing field parsing on source code of the circuit drawing; and
extract the description information of the target electronic component from the source code.

16. The computer device according to claim 15, wherein the computer instructions to determine the target electronic component in the circuit drawing by performing field parsing on the source code of the circuit drawing comprise instructions to:
determine a field in the circuit drawing by performing the field parsing on the source code; and
determine a target field by filtering the field, and taking an electronic component corresponding to the target field as the target electronic component.

17. The computer device according to claim 15, wherein the computer instructions to extract the description information of the target electronic component from the source code comprise instructions to:
extract a connection relationship between the target electronic component and model information of the target electronic component to obtain the description information.

18. The computer device according to claim 11, wherein the computer instructions to acquire the matching result of matching the first feature information corresponding to the first drawing file with each second feature information in the target feature information set comprise instructions to:
determine a similarity between a first feature vector and each second feature vector by matching the first feature vector with each of the second feature vector, the first feature vector corresponding to the first feature information, and the second feature vector corresponding to the second feature information; and
obtain the matching result between the first feature information and each of the second feature information based on a comparison result between the similarity and a preset similarity threshold.

19. The computer device according to claim 18, wherein the computer instructions to perform security protection management on the first drawing file based on the matching result comprise instructions to:
in response to existence of the second feature vector whose matching result represents that the similarity is greater than or equal to the preset similarity threshold, determine a target management level of the first drawing file based on a management level of the protected drawing file corresponding to the matched second feature vector, so as to perform the security protection management on the first drawing file according to the target management level.

20. A computer-readable storage medium, wherein the computer-readable storage medium stores computer instructions thereon, and the computer instructions are used to cause a computer to:
acquire a first drawing file;
acquire a matching result of matching first feature information corresponding to the first drawing file with each second feature information in a target feature information set, wherein the first feature information is obtained by parsing the first drawing file to obtain description information of a target element in the first drawing file, and performing feature extraction on the obtained description information of the target element, and the target feature information set comprising second feature information of at least one protected drawing file; and
perform security protection management on the first drawing file based on the matching result.
